(19) United States
(12) Patent Application Publication
(10) Pub. No.: US 2004/0058259 A1
(43) Pub. Date: Mar. 25, 2004

(54) Electrostatic charge image developing toner and image forming apparatus using the same

(75) Inventors: Junji Kobayashi, Ibaraki (JP); Hirobumi Ouchi, Ibaraki (JP); Shigenori Yaguchi, Ibaraki (JP); Ryuuichi Shimizu, Ibaraki (JP); Tsuneaki Kawanishi, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Printing Solutions, Ltd., Ebina-City (JP)

(21) Appl. No.: 10/662,340

(22) Filed: Sep. 16, 2003

(30) Foreign Application Priority Data
Sep. 20, 2002 (JP) P.2002-275451

(51) Int. Cl. G03G 9/08

(52) U.S. Cl. 430/108.1; 430/109.3; 430/108.8; 430/111.4

(57) ABSTRACT

In an electrostatic charge image developing toner containing at least a fixing resin and a wax, assume that the wax is used as one type wax or a mixed system of K types (K is an integer in excess of 2) waxes, Tn (°C.) is an onset temperature of an absorbed heat quantity curve of a wax constitutive component N in a differential scanning calorimeter (DSC), and Wn (wt %) is a compound rate occupied in an overall wax, the toner that satisfies predetermined relationships among them is obtained.

### BACKGROUND OF THE INVENTION

1. Field of the Invention

The present invention relates to an electrostatic charge image developing toner used to visualize an electrostatic charge latent image, which is formed by using the electrophotography method, the electrostatic printing method, the electrostatic recording method, or the like, and an image forming apparatus using the same.

2. Background Art

In the electrophotography method, for example, out of the electrophotography method, the electrostatic printing method, and the electrostatic recording method, the recording image is obtained by forming an electrostatic charge latent image on the photoconductive photoreceptor by charging/exposing a surface of the photoreceptor as the electrostatic charge bearing member, then developing the electrostatic charge latent image by using the fine grain toner that contains the coloring agent, etc. in the resin as the binder, and then transferring/fixing the resultant toner image onto the recording medium such as the paper, or the like.

In such electrostatic image recording steps, development of the electrostatic charge latent image by the fine grain toner and fixing of the image onto the recording medium are particularly important steps. As the developing method, the magnetic brush developing method employing the binary developer consisting of the toner, which makes the high-speed and high-picture quality development possible, and the magnetic carrier is often used. Also, as the fixing method, the heat roller fusing method, which has a high thermal efficiency and makes the high-speed fixing possible, is often used.

Meanwhile, recently the laser beam printer that uses the laser beam to expose the photoconductive photoreceptor and reproduces the recorded image by dots in compliance with the modulation signal, which is generated based on the instruction issued from the computer, is developed with the progress of the information equipments. In particular, since the higher picture quality in the image recording is required of the recent laser beam printer, the diameter of the laser beam is narrowed down and thus the dot density is increased like 600 to 1200 dpi (dots/inch). According to this, particle sizes of the toner and the carrier are made small for the purpose of developing the fine electrostatic charge latent image. Thus, the application of the fine grain toner whose volume-average particle size is 10 μm or less and the fine grain carrier whose weight-average particle size is 100 μm or less is advanced.

By the way, the above heat roller fusing is often used in the fixing. In this case, the consumption power of the fixing heater and the driving motor must be lowered from viewpoints such as prevention of thermal degradation of the parts in the apparatus by suppressing the superheat degradation of the printer, shortening of a warm-up time required until the fixing operation can be carried out after the fixing unit is operated, maintenance of the picture quality during the continuous paper feeding by preventing the incomplete fixing because the heat is absorbed by the recording medium, prevention of the curl of the recording medium and the fire due to the superheat, simplification and size reduction of the configuration of the fixing unit by reducing the load applied to the heat roller, etc. Thus, the development of the toner that is able to fix the image at a lower temperature of the heat roller and a lower pressure of the heat roller is desired. As described above, the development of the high performance toner that can fix the image at the low temperature and the low pressure by using the fine particles is desired.

Meanwhile, as described above, if the size of the toner is reduced to the fine grain of 10 μm or less, following problems are caused. In other words, if the fine grain toner is used in the developing step, the high picture quality can be obtained, but the adhesion (fog) of the toner onto the non-image portion and the scattering of the toner are easily caused and also the handling properties such as the toner transfer, etc. are easily lowered because of the reduction in the fluidity.

In addition, because of the strength of the adhesion force and the weakness of the impact resistance of the fine grain toner, the carrier contamination due to the toner is easily caused and thus the life of the developer is easily lowered.

Also, an energy that is larger than that required for the toner with a large particle size is needed in the fixing to get the same fixing strength, and yield of the classifying step is lowered at the time of manufacturing the toner. Thus, a cost of the toner is raised. These many problems are caused by the fine grain toner. Normally it is difficult to put the toner with a size of 5 μm or less into practical use. Therefore, the average particle size of the toner is classified in the range of 6 μm to 10 μm, and then the fluidity of the toner in use is enhanced by the external additive of the toner and improvement in the externally adding prescription. In contrast, with the reduction in the particle size of the toner, the frictional charging property of the carrier to the toner is improved by setting the weight-average particle size to the small particle size of 100 μm or less and also increasing the specific surface area of the carrier. However, in the carrier having the size of 30 μm or less, a magnetic force of the carrier is lowered and the carrier is adhered easily on the electrostatic charge bearing member by the electrostatic attractive force. Therefore, the average particle size of the carrier is classified in the range of 30 μm to 100 μm, and then a surface of the carrier is coated with a resin as the case may be.

Because of the improvement of the particle size distribution and improvements of the fluidity and the electrostatic property, the fine grain toner and the developer can be practically used in the image forming apparatus that is typified by the copying machine or the printer. However, if the high-speed printing in excess of 10 pages per minute is repeated, the problem peculiar to the fine grain toner is caused and reduction in the life of the developer due to the carrier contamination by the toner is easily caused. Also, it is hard to attain the fixing strength of the image, and thus the temperature and the pressure of the heat roller must be enhanced particularly in the fixing step. Therefore, there is such a problem that it is difficult to achieve the higher reliability, the simplification and the reduction in size, and the reduction in cost of the fixing unit.

It is publicly known in JP-A-52-3304, JP-A-52-3305, and JP-A-57-52574, etc., for example, that the wax should be added to the fixing resin to improve the fixing performance of the toner. The wax, and the like are employed to improve the fixing property of the toner at the time of low temperature by preventing the adhesion of the toner onto the heat roller at the time of low temperature or high temperature, i.e., the so-called offset phenomenon. In recent, the low-melting wax is watched with interest from the viewpoint of the low-temperature fixing.

It is disclosed in JP-A-5-313413, for example, that, in order to improve the low-temperature fixing property, the offset resistance, and the non-aggregation property of the toner, the ethylene or propylene whose viscosity at 140 ° C. is one ten thousand poise or less and the a-olefin copolymer should be added to the vinyl copolymer that has a particular molecular weight distribution.

Also, for the similar purpose, it is disclosed in JP-A-7-287413 that the paraffin wax whose peak (melting point) of the absorbed heat quantity measured by the differential scanning calorimeter (DSC) is at 75° C. to 85° C. should be added. Also, it is disclosed in JP-A-8-314181, JP-A-9-179335, and JP-A-9-319139 that the natural gas Fischer-Tropsch wax whose melting point measured by the DSC is at 85° C. to 100° C. should be added. Also, it is disclosed in JP-A-6-324513 that the polyethylene wax whose melting point measured by the DSC is at 85° C. to 110° C. should be added.

Also, it is disclosed in JP-A-7-36218 that the polyethylene wax whose melting point measured by the DSC is set in the range of 70° C. to 120° C. by removing the component whose melting point is set to 50° C. or less by virtue of the distillation process, or the like should be added. In addition, it is disclosed in JP-A-8-114942 that the polyethylene wax whose weight-average molecular weight (Mw) is below one thousand should be added.

By the way, if the low-melting wax is added to the toner, the heat resistance and the durability of the toner are lowered. In order to improve this, it is disclosed in JP-A-6-123994 that the wax whose ratio of weight-average molecular weight/number-average molecular weight (Mw/Mn) is 1.5 or less should be used, it is disclosed in JP-A-7-209909 that the ethylene olefin polymer wax whose melt viscosity at 140° C. is 0.5 mpa·s to 10 mPa·s and whose penetration is 3.0 dmm or less should be used, and it is disclosed in JP-A-7-287418 that the Fischer-Tropsch wax whose average molecular weight is one thousand or more should be used.

It is possible to improve the fixing performance of the toner by using the above prior art. However, if the low-melting wax is employed, it is difficult particularly to improve the fixing performance of the fine grain toner while maintaining the heat resistance and the durability of the toner. In particular, it is impossible to provide a toner and an image forming apparatus, which are capable of achieving the stable printing a variation of which due to the environment is small.

It is an object of the present invention to provide a toner capable of achieving the stable printing a variation of which due to the environment is small, and an image forming apparatus using the same.

### SUMMARY OF THE INVENTION

To achieve the object, the present invention provides an electrostatic charge image developing toner, comprising:

a fixing resin; and

one type wax or K type (K is an integer in excess of 1) waxes;

wherein following formulae (1) and (2) are satisfied

$$T = {\sum }_{N = 1}^{k} Tn \cdot Wn / 100 \qquad ( 1 )$$

T≧56 (2)

where Tn (° C.) is an onset temperature of an absorbed heat quantity curve of a wax constitutive component N in a differential scanning calorimeter (DSC), and Wn (wt %) is a compound rate occupied in an overall wax.

The invention may provide The image forming apparatus comprising:

an electrostatic charge holding member for holding an electrostatic latent image;

a developing unit for developing the electrostatic latent image by using the electrostatic charge image developing toner.

### BRIEF DESCRIPTION OF THE DRAWINGS

The present invention may be more readily described with reference to the accompanying drawings:

FIG. 1 is a graph showing absorbed heat quantity curve in DSC.

FIG. 2 is an overall configurative view of a laser beam printer to which the present invention is applied.

### DETAILED DESCRIPTION OF THE PREFERRED EMBODIMENTS

Embodiments of the present invention will be explained in detail hereinafter. Normally, as the fixing resin of the toner, the styrene-(meta)acryl resin or the polyester resin is employed in the heat roller fusing. Normally the polyester resin has the polar groups with the high moisture-absorbing property (the hydroxyl group, the carboxyl group). Thus, there are such tendencies that, since the toner is ready to absorb the moisture, the storage stability of the toner is lowered and also the charging characteristic of the toner is ready to change. In recent, the resin having the low hygroscopic property in which the styrene-acryl is mixed in the polyester resin by the graft copolymerization was developed. The fixing performance of the toner can be improved by adding the wax, or the like into these fixing resins.

Normally, the wax, or the like is used for long as the offset preventing agent of the toner. In contrast, there are such problems that the heat resistance and the durability of the toner are lowered and the fusion is ready to occur. There are a wide variety of waxes, and they are used properly according to their functions. In this case, it is preferable from an aspect of preventing the offset of the toner that the hydrocarbon wax which is nonpolar and has the non-adhesive property to the heat roller should be used.

The hydrocarbon wax is the aggregate of hydrocarbon molecules having a molecular weight distribution, and the characteristic of the hydrocarbon wax depends largely on the molecular weight distribution. Normally the hydrocarbon wax produces an effect of preventing the high-temperature offset, and also produces effects of preventing the low-temperature offset and the improvement of the low-temperature fixing by increasing low molecular weight components.

However, if the low molecular weight components are increased to improve the fixing performance, the heat resistance and the durability are lowered and thus the fusion of the developer into the carrier is easily caused. Hence, the rationalization of the molecular weight distribution is tried by cutting the low molecular weight components of the existing hydrocarbon wax. More particularly, in above JP-A-6-123994, in the molecular weight distribution that is measured by the gel permeation chromatography (GPC), the molecular weight distribution of the wax is sharpened such that the ratio of weight-average molecular weight/number-average molecular weight (Mw/Mn) is set to 1.5 or less, preferably 1.45 or less.

However, according to the study of the inventors of this application, it was found that, if the molecular weight distribution of the hydrocarbon wax is sharpened as described above, the heat resistance and the durability are improved but the fixing performance becomes insufficient, particularly the fixing performance is lowered when the high-speed printing in excess of 10 pages per minute is repeated.

Therefore, the inventors of this application apply the wax mixture whose the molecular weight distribution is rationalized by combining the waxes, whose molecular weight distribution is rationalized by containing appropriately the low molecular weight components, or the waxes, which have the narrow the molecular weight distribution, with each other to the toner. As the result of the evaluation of various characteristics, it was found that the melting point, which is defined as the maximum peak of the absorbed heat quantity curve at the time of temperature rise, is set in the range of 50° C. to 120° C. in the DSC curve measured by the differential scanning calorimeter and thus, if the wax whose crystallinity being measured by the X-ray diffraction method is more than 85% but less than 93% is used as the constitutive element, the fixing performance of the toner can be obtained sufficiently.

Here, the melting point of the wax measured by the DSC must be stipulated in the range of 50° C. to 120° C. The fusing property of the toner is increased and also the high-temperature offset is readily caused if the melting point of the wax is below 50° C., while the fixing property of the toner is lowered if the melting point of the wax is equivalent to or in excess of 120° C. In contrast, there exists a correlation between the crystallinity of a single wax and the molecular weight distribution of the wax. There is such a tendency that the molecular weight distribution is decreased as the crystallinity is increased. According to the study of the inventors of this application, if the crystallinity of the wax is increased to exceed the above range, the molecular weight distribution of the wax becomes small and also the low molecular weight components are reduced. Therefore, the sufficient fixing property cannot be obtained in the high-speed printing using the fine grain toner. Also, if the crystallinity of the wax becomes smaller than the above range, the molecular weight distribution of the wax becomes large and also the low molecular weight components are increased. Therefore, the toner is easily fused and thus the offset resistance is lowered. In other words, if the wax having the melting point and the crystallinity, both being set in the range of the present invention, is added to the fixing resin by an appropriate amount, the sufficient fixing performance can be obtained.

However, since the wax of the present invention has the low melting point and the small crystallinity, the heat resistance and the durability of the toner are ready to reduce and thus the degradation of picture quality is easily caused due to the reduction in characteristics of the toner due to the environment, particularly the reduction in the fluidity of the toner. In order to prevent this, under assumptions that the mixture consisting of one type or K types (K is an integer of 2 or more) wax is used as the toner, the onset temperature of the absorbed heat quantity curve in the DSC curve measured by the differential scanning calorimeter is Tn (° C.), and a compound rate that is occupied in the overall wax is Wn (wt %), recording/formation of the electrostatic toner image that is stable against environmental changes can be achieved if the toner is prepared to satisfy following equations (1) and (2).

$$T = {\sum }_{N = 1}^{k} Tn \cdot Wn / 100 \qquad ( 1 )$$

T≧56 (2)

If the wax of the present invention is added to the toner as the measure for the above, an addition amount, an adding method, etc. of the wax must be thought out.

In the toner of the present invention, an addition amount of the wax can be set in the range of 0.5 to 10 wt % with respect to a total amount of the fixing resin and the wax. More preferably, the wax should be added in the range of 3.0 to 6.0 wt %. An effect of improving the fixing performance of the toner is reduced if the addition amount of the wax is below 0.5 wt %, while the high-temperature offset of the toner is easily caused if the addition amount of the wax is in excess of 10 wt %.

If the dispersibility of the wax into the toner is improved and the dispersed particle size is reduced, the heat resistance and the durability of the toner can be improved. As the measure for this, there is the method of increasing an energy required at the time of thermally melting/kneading the toner to increase the miscibility of the wax and the fixing resin. However, according to this method, if the energy enough to improve the dispersibility of the wax is applied to the fixing resin, the fixing resin is subjected to the mechanical damage and also the fixing property and the high-temperature offset resistance are readily lowered.

Therefore, as another measure of improving the dispersibility of the wax, the concomitant polymerizing method in which the wax exists together in a part or all of synthesizing steps applied to synthesize the fixing resin was studied. At that time, the wax could be dispersed uniformly into the fixing resin without degradation of the resin. Also, it was found that, when the fixing resin obtained by the above method is applied to the toner, the heat resistance and the durability of the toner can be improved and thus degradation of the picture quality due to the reduction in the fluidity of the toner can be reduced.

Under assumptions that the toner containing the wax of the present invention is used as the mixture consisting of one type or K types (K is an integer of 2 or more) wax by employing these methods, the onset temperature of the absorbed heat quantity curve in the DSC curve measured by the differential scanning calorimeter is Tn (° C.), and the compound rate that is occupied in the overall wax is Wn (wt %), the recording/formation of the stable electrostatic toner image whose degradation of the picture quality due to the environment is small can be implemented if the toner is prepared to satisfy above equations (1) and (2).

In the present invention, the wax can be obtained from the natural wax or the synthetic wax. There are animal/plant wax, mineral wax, and petroleum wax as the natural wax. There are Fischer-Tropsch wax, polyethylene wax, etc. as the synthetic wax. The wax having the melting point and the crystallinity in the present invention is selected appropriately from these waxes and is used. Out of the synthetic waxes, the polyethylene wax is the low polymerized substance of polyethylene that is obtained industrially by the medium-pressure or low-pressure polyethylene polymerizing process using the Ziegler catalyst or the metallocene catalyst. This low polymerized substance of polyethylene is refined and then used. In other words, the wax of the present invention can be obtained by removing the oil component, the oligomer, etc. from this low polymerized substance of polyethylene by virtue of the vacuum distillation method, or the like, and then removing the low molecular weight components from the resultant distillated residual liquid at the high temperature and the highly lowered pressure as the case may be.

In the present invention, the crystallinity of the wax is measured by the X-ray diffraction method under following conditions.

X rays: Cu-Kα beam (monochromized by the graphite monochromator)

Wavelength λ=1.5406 Å

Outputs: 40 kV, 40 mA

Optical system: reflection method, slit DS,SS=1°, RS=0.3 mm

Measured range: 2θ=10° to 35°

Step interval: 0.02°

Scanning rate: 2θ/θ continuous scan 1.00°/min

The measurement was carried out, then the X-ray diffraction profile of the sample was separated into three crystal peaks and the noncrystalline scattering, and then the crystallinity was calculated by a following equation based on these areas.

Crystallinity (%)=Ic/(Ic+Ia) X100

Ic: sum of respective crystal peak areas

Ia: sum of respective crystal peak areas+noncrystalline scattering area

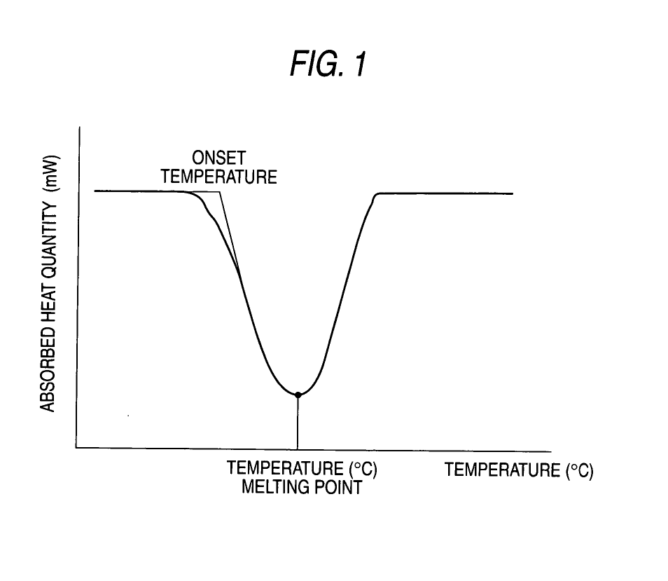

Also, since the heat exchange in the wax is measured in the DSC measurement to observe its behavior, it is preferable that the measurement should be executed by using the high-precision heat flux type differential scanning calorimeter in view of the measuring principle. For example, 2910 manufactured by TA instrument Co., Ltd. may be employed. As the measuring conditions, the wax is weighed by about 5 mg and loaded into the DSC, then the temperature is risen from about 20° C. to 200° C. while flowing a nitrogen gas into an inside at a rate of 50 ml/min, then the temperature is lowered from 200° C. to about 20° C. at a rate of about 10° C./min to get the prehistory, then the temperature is risen once again at a rate of 10° C./min, and then the melting point (Tmp in FIG. 1) that corresponds to the maximum value of the absorbed heat peak of the wax is calculated based on the maximum peak in the DSC absorbed heat quantity curve shown in FIG. 1 at that time.

The onset temperature is detected as an intersection point between a tangent line located at a position, at which a gradient of the endothermic peak curve detected at the time of temperature rise is changed, and a base line (the onset temperature in FIG. 1).

As other physical property of the wax, it is desired that the penetration measured at 25° C. should be set as small as possible. In the present invention, since the low molecular weigh components are contained appropriately in the wax having the small crystallinity, the penetration measured based on JIS-K-2207 is given as 0.5 to 10 dmm.

In the present invention, the addition amount and the adding method of the wax must be set properly to get the heat resistance and the durability of the toner. As to the fluidity of the toner, a correlation between change of the characteristic and degradation of the picture quality was examined. As a result, under assumptions that the toner containing the wax is used as the mixture consisting of one type or K types (K is an integer of 2 or more) wax, the onset temperature of the absorbed heat quantity curve in the DSC curve measured by the differential scanning calorimeter is Tn (° C.), and the compound rate that is occupied in the overall wax is Wn (wt %), the toner that is hard to cause the degradation of the picture quality due to the environment can be obtained if above equations (1) and (2) are satisfied.

In the present invention, the developer that is prepared by mixing the toner with the carrier is supplied to the laser beam printer and change of the picture quality due to the environment is evaluated. At that time, a mixed rate of the toner and the carrier, i.e., the so-called toner density is changed, which causes the degradation of the picture quality. The reason for this may be considered such that the toner is easily separated from the carrier because the fluidity of the toner is changed, especially the fluidity of the toner is lowered at the high-temperature and the high-humidity (32° C., 80% RH), then the toner is supplied excessively because it is decided in a toner density control unit using a magnetic sensor that the toner is in short supply, and then the degradation of the picture quality is caused because of the excessive development, so that the change in the fluidity of the toner due to the environment causes the degradation of the picture quality.

A variation of the toner density can be measured by the suction type blow-off charge quantity measuring unit by picking up the developer on the developing roller periodically. More particularly, the toner density can be measured by weighing the developer by about 0.2 g, then supplying such developer to the Faraday gauge to which a metal mesh of 400 mesh is fitted, and then separating the toner from the carrier by virtue of the predetermined suction and blow-off. Therefore, it is decided that, if an amount of change in the toner density due to the environmental change becomes smaller, the toner has the better fluidity and an amount of change in the image quality becomes smaller.

In the present invention, the temperature change of the toner density was measured by changing the atmospheric temperature of the location, on which the printer into which the toner of the present invention is filled is placed, within the range from the room temperature (about 20° C.) to 32° C. in printing. According to the toner of the present invention, the change in the toner density in this temperature range is reduced. In particular, under assumptions that the wax is used as the mixture consisting of one type or K types (K is an integer of 2 or more) wax, the onset temperature of the absorbed heat quantity curve in the DSC curve measured by the differential scanning calorimeter is Tn (° C.), and the compound rate that is occupied in the overall wax is Wn (wt %), the change in the toner density at the high temperature becomes small if above equations (1) and (2) are satisfied. Then, ΔTc defined by a difference between the toner density T₃₂ at 32° C. and the toner density T₂₀ at the room temperature never exceeds 0.3%, and the degradation of the picture quality at the high-temperature and the high-humidity (32° C., 80% RH) is small. Such change is the change within an allowable range that the client does not put in question.

This is because, in the environmental test of the printer in the present invention, the temperature of the developing unit for carrying/supplying the toner is supposed to exceed 45° C. in the high-temperature and the high-humidity (32° C., 80% RH) environment and thus the wax that appears on the surface of the toner is softened because of its heat absorption to lower the fluidity of the toner. Therefore, if the onset temperature T of the wax, which is detected based on the mixed ratio, is below 56° C., the wax is softened because of its heat absorption to lower the fluidity of the toner and then the toner is supplied excessively to enhance the increase of the toner density. The environmental stability can be decided based on the change in the picture quality itself. Similarly, the stability of the toner with respect to the environment can be evaluated based on the stability of the toner density.

As the fixing resin employed in the toner of the present invention, for example, resins may be listed as follows.

There are listed homopolymer of styrene or its substitution product such as polystyrene, poly-p-chlorstyrene, polyvinyltoluene, etc.; styrene copolymer such as styrene-p-chlorstyrene copolymer, styrene-vinyltoluene copolymer, styrene-vinylnaphthalene copolymer, styrene-acrylate copolymer, styrene-methacrylate copolymer, styrene-a-methyl chlormethacrylater copolymer, styrene-acrylonitrile copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-acrylonitrile-indene copolymer, etc.; and poly(vinyl chroride), phenol resin, natural modified phenol resin, natural resin modified maleate resin, acrylic resin, methacrylic resin, poly(vinyl acetate), silicon resin, polyester resin, polyurethane, polyamide resin, furan resin, epoxy resin, xylene resin, polyvinylbutyral, terpene resin, chroman-indene resin, petroleum resin, etc. Preferably, styrene copolymer or polyester resin may be employed. Also, the resin having the low hygroscopic property, which is formed by mixing styrene-acryl into the above polyester resin by the graft copolymerization, may be employed. In this case, styrene polymer or styrene copolymer may be bridged, and also mixed resin may be employed.

The vinyl copolymer employed in the fixing resin of the present invention may contain the styrene monomer and/or the (meta) acrylate monomer as the constitutive unit. Also, the vinyl copolymer can contain the vinyl monomer except the above monomers.

As examples of the styrene monomer in the present invention, o-methlstyrene, m-methlstyrene, p-methlstyrene, α-methlstyrene, p-ethlstyrene, 2,4-dimethlstyrene, p-n-butylstyrene, p-ter-butylstyrene, p-n-hexylstyrene, p-n-octylstyrene, p-n-dodecylstyrene, p-methoxystyrene, p-phenylstyrene, p-chlorstyrene, 3,4-dichlorstyrene, etc. may be listed in addition to the styrene.

As examples of the acrylate or methacrylate monomer in the present invention, 2-chlorethyl acrylate, phenyl acrylate, metyl α-chloracrylate, phenyl methacrylate, dimethylaminoethyl methacrylate, diethylaminoethyl methacrylate, 2-hydroxyethyl methacrylate, glycidyl methacrylate, bisglycidyl methacrylate, polyethylene glycol methacrylate, methacryloxy ethyl phosphate, etc. maybe listed in addition to alkyl ester acrylate or methacrylate such as methyl acrylate, ethyl acryl ate, propyl acrylate, n-butyl acrylate, isobutyl acrylate, n-octyl acrylate, dodecyl acrylate, 2-ethylhexyl acrylate, stearyl acrylate, methyl methacrylate, ethyl methacrylate, propyl methacrylate, n-butyl methacrylate, isobutyl methacrylate, n-octyl methacrylate, dodecyl methacrylate, stearyl methacrylate, etc. In particular, ethyl acrylate, propyl acrylate, butyl acrylate, methyl methacrylate, ethyl methacrylate, propyl methacrylate, butyl methacrylate, etc. should be preferably employed.

As other vinyl monomers in the present invention, acrylic acid such as acrylic acid, methacrylic acid, α-ethyl acrylic acid, crotonic acid, etc. and their α- or β-alkyl derivative, unsaturated dicarboxylic acid such as fumaric acid, maleic acid, citraconic acid, itaconic acid, etc., and their monoester derivative and diester derivative, monoacryloyloxyethyl ester succinate, monomethacryloyloxyethyl ester succinate, acrylonitrile, methacrylonitrile, acrylamide, etc. may be listed.

The fixing resin in the present invention can be obtained to contain at least the vinyl copolymer, in which the wax is dispersed uniformly, as the constitutive element by executing the concomitant polymerization, which makes it possible to exist the wax of the present invention together, as a part or all of synthesizing steps while using these vinyl monomers. In this case, the vinyl copolymer may be bridged partially by the crosslinking agent made of the monomer, which has two polymeric double bonds or more mainly, e.g., divinylbenzene, divinylnapthalene, ethylene glycol dimethacrylate, 1,3-butanediol dimethacrylate, divinylaniline, divinylether, divinylsulfide, divinylsulfone, etc.

If the charging controlling agent is blended (internally added) or mixed (externally added) into toner particles of the toner of the present invention, a quantity of charge of the toner can be controlled at a desired value.

As the positive charging controlling agent of the toner, denaturated substance made of nigrosine and fatty acid metal salt, etc.; tributylbenzyl ammonium-1-hydroxy-4-naphthosulfonic acid, quaternary ammonium salt such as tetrabutyl ammonium tetrafluoroborate, and onium salt such as phosphonium salt as these analogs, etc. and these lake pigments, triphenylmethane dye and these lake pigments, metal salt of higher fatty acid; diorgano tin oxide such as dibutyl tin oxide, dioctyl tin oxide, dicyclohexyl tin oxide, etc.; diorgano tin borate such as dibutyl tin borate, dioctyl tin borate, dicyclohexyl tin borate, etc.; and the combination of two above substances or more may be employed. In particular, preferably the charging controlling agent such as the nigrosine, the quaternary ammonium salt, the triphenylmethane dye among them should be employed.

As the negative charging controlling agent of the toner, organic metal complex and chelate compound are effective, and there are monoazo metal complex, acetylacetone metal complex, and metal complex of aromatic hydroxycarboxylic acid or aromatic dicarboxylic acid. In addition, there are aromatic hydroxycarboxylic acid, aromatic mono and polycarboxylic acid and their metal salt, anhydride, ester, phenol derivative such as bisphenol.

It is preferable that, if these charging controlling agents are internally added to the toner, such agents should be added by 0.1 to 10 wt % of the fixing resin.

It is preferable that, in order to improve the developing property, the fluidity, and the durability, silica impalpable powders should be externally added to the toner of the present invention. The silica impalpable powders each having a specific surface area of 10 m²/g or more due to the nitrogen adsorption measured by the BET method are preferable, and such silica impalpable powders are externally added in the range of 0.01 wt % to 5 wt % of the fixing resin. Also, the silica impalpable powders are employed by applying the hydrophobization or controlling the charging property while using the treating agent such as organic silicon compound, or the like or various treating agents, as the case may be.

In addition, as other additive of the toner, lubricant powders such as Teflon (trademark) resin powders, zinc stearate powders, poly(vinylidene fluoride) powders, for example, are employed, and especially poly(vinylidene fluoride) powders are preferable. Otherwise, the abrasive such as cerium oxide powders, silicon carbide powders, strontium titanate powders, etc., are employed, and especially strontium titanate powders are preferable. Otherwise, the fluidity applying agent such as titanium oxide powders, aluminum oxide powders, for example, is employed, and especially the hydrophobic fluidity applying agent is preferable. The aggregation preventing agent, or the conductivity applying agent such as carbon black powders, zinc oxide powders, antimony oxide powders, tin oxide powders, for example, or the development improving agent such as white fine grains and black fine grains with opposite polarities may be employed by a small amount.

If the toner of the present invention is employed as the binary system developer, such toner is mixed with the carrier. In this case, it is preferable that a mixed ratio of the toner and the carrier should be set to 2 to 10 wt % as the toner density. As the carrier that is available for the present invention, the well-known carrier can be employed. For example, iron powders, ferrite, magnetite, glass beads, and carriers obtained by treating the surface of the above by fluororesin, vinyl resin, silicone resin, or the like are employed.

As the coloring agent that is available for the toner of the present invention, any appropriate pigment or dye may be listed. As the coloring agent of the toner, for example, there are carbon black, anilineblack, acetyleneblack, naphthol yellow, Hansa yellow, Rhodamine lake, alizarin lake, bengal, phthalocyanine blue, and indanthrene blue as the pigment. These agents are employed by a necessary and sufficient amount to maintain the optical density of the fixed image. Preferably these agents are added to the resin by 0.2 to 15 wt %.

In addition, the dye is employed for the same purpose. For example, there are azo dye, anthraquinone dye, xanthene dye, and methine dye. These dyes are added to the resin by 0.2 to 15 wt % In order to manufacture the electrostatic charge image developing toner in the present invention, the fixing resin and the wax, the charging controlling agent, the pigment or dye as the coloring agent, magnetic powders, and other additive, as occasion demands, are mixed sufficiently by the mixer such as Henschel mixer, super mixer, or the like, then materials are mixed sufficiently by melting/kneading using the thermal melting kneading machine such as the heat roller, the kneader, the extruder, etc., and then such materials are cooled/solidified and then finely ground and classified, so that the toner whose average particle size is 6 to 10 μm can be obtained. In addition, as the case may be, the toner to which the additive is externally added can be obtained by adhering/mixing the desired additive to/into the toner by virtue of the mixer such as the Henschel mixer.

The toner of the present invention exhibits the good fixing performance particularly in the image forming apparatus that visualizes the electrostatic charge latent image, which is formed on the photosensitive body as the electrostatic charge bearing member, by using the binary system developer consisting of the toner and the carrier, then transfers the visualized toner image onto the recording medium, and then fixes the toner image by heating the recording medium that bears the toner image thereon. Thus, the heat resistance and the durability of the toner become good, and also the image forming apparatus that is capable of recording/forming the stable electrostatic toner image, in which the reduction in the picture quality caused by the toner due to the environmental change is hard to occur, can be provided.

Examples of the present invention will be explained hereinafter, but the present invention is not limited to these examples.

At first, physical properties of the wax and the adding method will be studied hereunder.

As the wax of the present invention, polyethylene wax A, paraffin waxes B, C, alpha olefin wax D, and Fischer-Tropsch waxes E, F were selected from the synthetic waxes and/or the natural waxes. As the comparative Example, paraffin wax G and polyethylene wax H were used. The physical properties of these waxes are given in Table 1.

### EXAMPLE 1

The toner material having the compound consisting of styrene-acryl copolymer resin (weight-average molecular weight is about 240 thousand, peak molecular weight of the high molecular weight substance is about 550 thousand, and peak molecular weight of the low molecular weight substance is about 4 thousand) 85 wt %, chromeazo metal complex (product name: Bontron S-34 manufactured by Orient Chemical Industry Co., Ltd.) 1 wt %, carbon black (product name: #44 manufactured by Mitsubishi Chemical Co., Ltd.) 10wt %, and the wax consisting of polyethylene wax A 4.25 wt % and paraffin wax B 0.75 wt % (wax compound ratio: A=85%, B=15%) was mixed previously by the super mixer, then thermally melted/kneaded by the biaxial kneading machine, then ground by the jet mill, and then classified by the dry airflow classifier. Thus, the particles whose average grain size is about 9 μm were obtained.

Then, the toner was obtained by adding the hydrophobic silica (product name: Aerogel R972 manufactured by Nihon Aerogel Co., Ltd.) 0.8 wt % to the above particles, and then stirring them by the Henschel mixer to adhere the hydrophobic silica onto the surfaces of the particles.

### EXAMPLES 2, 3, 4, 5

Respective toners were manufactured in the same way as Example 1 except that the polyethylene wax A 3.75 wt % and the paraffin wax C 1.25 wt % (wax compound ratio: A=75%, C=25%) were employed in Example 2, that the polyethylene wax A 3.5 wt % and the alpha plefin wax D1.5 wt % (wax compound ratio: A=70%, D=30%) were employed in Example 3, that the Fischer-Tropsch wax E was employed in Example 4, and that the Fischer-Tropsch wax F was employed in Example 5.

### COMPARATIVE EXAMPLES 1, 2

Respective toners were manufactured in the same way as Example 1 except that the paraffin wax G and the polyethylene wax H were employed.

Next, the method of adding the wax to the fixing resin will be studied hereunder.

### EXAMPLE 6

The resin whose maximal value of the molecular weight distribution is about 500 thousand was obtained by polymerizing the styrene 70 wt %, the methyl methacrylate 10 wt %, and the n-butyl acrylate 20 wt %. The mixture of this resin 200 g and the Fischer-Tropsch wax E 40 g were put into a separable flask and then dissolved by the xylene 1 liter, then the vapor phase was substituted with a nitrogen gas, and then this system was heated up to a boiling point (135° C. to 145° C.) of the xylene.

The solution polymerization was carried out by dropping the mixture, in which the styrene 440 g, n-butyl acrylate 65 g, and t-butylperoxy2-ethylhexanoate 30 gas the polymerization initiator are dissolved, to spend about 2.5 hours while stirring them in the state that the circumfusion of xylene is caused. Thus, the low molecular weight polymer components were polymerized in the situation that the high molecular weight polymer and the Fischer-Tropsch wax exist. After the dropping was completed, the polymer was matured for one hour while stirring at the temperature at which the xylene boils. Then, the resin HT-1 whose peak of the molecular weight distribution on the low molecular weight side is about 8thousands was obtained by removing the xylene at the low pressure while increasing gradually the temperature of the system up to 180° C. In this resin HT-1, an amount of contained Fischer-Tropsch wax was about 5.4 wt %.

Then, the toner material having the compound consisting of styrene-acryl copolymer resin HT-189 wt % containing the Fischer-Tropsch wax E, chromeazo metal complex (product name: Bontron S-34 manufactured by Orient Chemical Co., Ltd.) 1 wt %, and carbon black (product name: #44 manufactured by Mitsubishi Chemical Co., Ltd.) 10 wt % was mixed previously by the super mixer, then thermally melted/kneaded by the biaxial kneading machine, then ground by the jet mill, and then classified by the dry airflow classifier. Thus, the particles whose average grain size is about 9 μm were obtained.

Then, the toner of the present invention was obtained by adding the hydrophobic silica (product name: Aerogel R972 manufactured by Nihon Aerogel Co., Ltd.) 0.8 wt % to the above particles, and then stirring them by the Henschel mixer to adhere the hydrophobic silica onto the surfaces of the particles.

Temperature changes of the fixing performance and the fluidity and environmental change of the picture quality of the toners in above Examples and Comparative Examples were evaluated by following methods.

(1) Non-Offset Temperature Range

In the electrophotography system laser beam printer using the organic photoconductive photoreceptor (OPC) as the photosensitive body, the printing was executed at a printing speed of 60 sheet/min under the conditions of an OPC charged potential −650 V, a residual potential −50 V, a developing bias potential −400 V, and a developing portion contrast potential 350 V. In the developing unit, the magnetite carrier (electric resistance 4.1×10⁸ Ω·cm), which is coated with the silicon resin containing the conductivity applying agent and whose weight-average particle size is about 90 μm, was used as the carrier. The developer was prepared to have the toner density of about 2.5 wt %. A developing gap (a distance between a surface of the photoreceptor and a surface of the developing roller) in the magnetic brush developing method was set to 0.8 mm. The photoreceptor and the developing roller are arranged to move in the same direction in the developing area. A peripheral speed ratio of both (developing roller/photoreceptor) was set to 3. Then, the image was produced according to the reversal system.

In the fixing unit, a roller in which an aluminum core is coated thinly with a fluororesin (tetrafluoroethylene-perfluoroalkylvinylether copolymer: PFA) tube (thickness about 40 μm) and a heater lamp is arranged at its center portion was used as the heat roller, and a roller in which the aluminum core is coated with a silicon rubber layer (thickness 7 mm) having a rubber hardness of about 30 degree and its outermost layer is coated with the PFA tube was used as the back-up roller. As the fixing conditions, a process speed is 26.7 cm/sec, outer diameters of the heat roller and the back-up roller are 60 mm, a pushing load is 50 kgf, and a width of the contact area (nip) between them is about 7 mm. While changing the control temperature of the heat roller, the offset was evaluated based on the contamination on the white paper portion of the fixed image at respective surface temperatures of the heat roller. In this case, essentially the cleaner of the nomex paper winding type, which is impregnated with the silicon oil, is fitted to the heat roller. When the offset is to be evaluated, the cleaner was removed and then the image was recorded on the thick paper (thickness about 200 μm) and the thin paper (thickness about 100 μm) in the silicon-oil less state. The low-temperature offset was evaluated based on the former whereas the high-temperature offset was evaluated based on the latter.

(2) Fixing Strength

The surface temperature of the heat roller in the above fixing unit is set to 175° C., and the full black image having a 1-inch square and the line drawing depicted by 1-ON and 4-OFF intervals of the laser beam are recorded on the thick paper (thickness about 200 μm). Thus, the fixing strength of the image was evaluated by applying the tape peeling test and the rubbing test to such full black image and such line drawing respectively.

In the tape peeling test, the Scotch (trademark) mending tape 810 was pasted onto the full black image, then the image density was measured by the reflection densitometer (RD-914 manufactured by Macbeth Co., Ltd.) before and after the tape is peeled off, and then the tape peeling strength was calculated based on “Tape peeling strength (%)=(reflection density of the full black image after the tape is peeled off/reflection density of the full black image before the tape is peeled off)×100”.

In the rubbing test, the rubbing strength (%) was derived by rubbing the line drawing with the Wattmann filter paper at the load of 200 gf, then a degree of contamination of the filter paper was evaluated by the brightness meter, and then calculating a ratio of the light reflection factors as the Hunter's value (%)

(3) Measurement of the Toner Density

The toner density can be measured by picking up the developer on the developing roller an then measuring such developer by using the suction type blow-off charge quantity measuring device (manufactured by Toshiba Chemical Co., Ltd.). In other words, toner density was measured by weighing the developer by about 0.2 g, then supplying such developer to the Faraday gauge to which the metal mesh of 400 mesh is fitted, and then separating the toner from the carrier by virtue of the predetermined suction and blow-off.

(4) Evaluation of the Picture Quality

The change in the picture quality from the ordinary-temperature and the ordinary-humidity (23° C., 50% RH) was examined by putting the above electrophotography system laser beam printer into the environmental testing room that is set to the high-temperature and the high-humidity (32° C., 80% RH), then setting the surface temperature of the heat roller to 185° C., then supplying the silicon oil to the heat roller, and then evaluating the printed images recorded on the standard paper (thickness about 100 μm) with the eye up to about 10 thousand pages.

Evaluation results of above items of the toner are shown in Tables 1 and 2.

TABLE 1

| | Properties of the wax added to the toner | | | | |
|---|---|---|---|---|---|
| | | | | | Onset |
| | Wax type | | Melting | | temperature |
| | (wt % of the wax in | | point | Onset | (° C.) by the |
| | a resin total | Crystallinity | (° C.) in | temperature | compound |
| | amount) | (%) | DSC | (° C.) in DSC | ratio |
| Example 1 | Polyethylene | 93 | 92.8 | 68.1 | 63.4 |
| | wax A | | | | |
| | Paraffin wax B | 89 | 67.5 | 49.1 | |
| | melt mixed into | | | | |
| | resin about 5.0) | | | | |
| Example 2 | Polyethylene | 93 | 92.8 | 68.1 | 61.3 |
| | wax A | | | | |
| | Paraffin wax C | 86 | 63.9 | 40.8 | |
| | (melt mixed into | | | | |
| | resin about 5.0) | | | | |
| Example 3 | Polyethylene | 93 | 92.8 | 68.1 | 59.1 |
| | wax A | | | | |
| | α-olefin wax D | 81 | 63.2 | 38.0 | |
| | (melt mixed into | | | | |
| | resin about 5.0) | | | | |
| Example 4 | Fischer-Tropsch | 90 | 93.8 | 78.9 | 78.9 |
| | wax E | | | | |
| | (melt mixed into | | | | |
| | resin about 5.0) | | | | |
| Example 5 | Fischer-Tropsch | 90 | 79.9 | 60.8 | 60.8 |
| | wax F | | | | |
| | (melt mixed into | | | | |
| | resin about 5.0) | | | | |
| Example 6 | Fischer-Tropsch | 90 | 93.8 | 78.9 | 78.9 |
| | wax E | | | | |
| | (concomitant | | | | |
| | polymerization | | | | |
| | into resin about | | | | |
| | 5.4) | | | | |
| Comparative | Paraffin wax G | 86 | 63.9 | 51.4 | 51.4 |
| Example 1 | (melt mixed into | | | | |
| | resin about 5.0) | | | | |
| Comparative | Polyethylene | 83 | 83.2 | 34.0 | 34.0 |
| Example 2 | wax (melt mixed | | | | |
| | into resin about | | | | |
| | 5.0) | | | | |

TABLE 2

| | The toner fixing performance | | | | |
|---|---|---|---|---|---|
| | and change in the toner density due to temperature | | | | |
| | | | | | Picture quality |
| | | | | ΔTc (change in | by the |
| | | | | the toner | laser printer |
| | | Tape | | density) (%) Wax | at high- |
| | Non-offset | peeling | Rubbing | type (wt % of the | temperature and |
| | temperature | strength | strength | wax in a resin | high-humidity |
| | range (° C.) | (%) | (%) | total amount) | (23, 80% RH) |
| Example 1 | 165 -> 220 | 88.5 | 88.5 | 0.17 | good |
| Example 2 | 165 -> 220 | 89.2 | 89.2 | 0.26 | good |
| Example 3 | 165 -> 220 | 90.5 | 90.5 | 0.27 | good |
| Example 4 | 165 -> 220 | 82.5 | 82.5 | 0.10 | good |
| Example 5 | 165 -> 220 | 83.2 | 83.2 | 0.22 | good |
| Example 6 | 165 -> 220 | 84.3 | 84.3 | 0.18 | good |
| Comparative | 165 -> 220 | 85.1 | 85.3 | 0.37 | bad |
| Example 1 | | | | | |
| Comparative | 165 -> 220 | 84.8 | 84.3 | 0.52 | bad |
| Example 2 | (Winding on | | | | |
| | the heat | | | | |
| | roller is | | | | |
| | generated.) | | | | |

As apparent from the evaluation results in Tables 1 and 2, in the toner shown in Examples 1 to 6 according to the present invention, the non-offset temperature range was wide, and the tape peeling strength and the rubbing strength as the fixing strength at the fixing temperature of 175° C. exceeded 80%. Thus, the fixing strength that is practically available could be implemented. Also, an amount of change in the toner density (ΔTc) could be suppressed smaller than 0.30%. Thus, if the toner of the present invention was applied to the above laser beam printer, the good image could be obtained even at the high-temperature and the high-humidity environment.

In contrast, the toner in Comparative Examples 1, 2 has the defect in any of the non-offset temperature range, the fixing strength, and the amount of change in the toner density (ΔTc). It was found that, if such toner is applied to the above laser beam printer, the stable image cannot be obtained at the high-temperature and the high-humidity.

A configuration of the above laser beam printer will be explained with reference to FIG.1 hereunder.

A reference 1 is a main body of the basic apparatus. The main body 1 of the basic apparatus has a printer portion 3 that can be pulled out from an apparatus frame 2. A reference 4 is a photosensitive drum on which the toner image is recorded/formed by the well-known electrophotography process. The photosensitive drum 4 is supported by the supporting axis to rotate at a predetermined speed in the direction indicated by an arrow a.

A charger 5 is arranged to oppose to a surface of the photosensitive drum 4, and charges uniformly the surface of the photosensitive drum 4 that is passed to oppose to this charger 5. A laser beam 6 exposes the surface of the photosensitive drum 4, which has been charged uniformly, and forms the electrostatic charge latent image on the surface of the photosensitive drum 4 in compliance with a printing information signal that is supplied from an information processing equipment.

A developing unit 7 is arranged to oppose to the surface of the photosensitive drum 4 on which the electrostatic charge latent image is formed. This developing unit 7 has a developing function that can form the toner image by depositing the above toner onto the surface of the photosensitive drum 4 by virtue of an electrostatic force of the electrostatic charge latent image.

A cassette 8 contains sheet-like recording medium (paper) 9, on which the toner image is transferred and fixed to print the image, in its piled state. A paper feeding roller mechanism 10 constituting a part of the recording member carrying means picks up the paper 9 from the cassette 8 and feeds such paper 9 to the photosensitive drum 4.

The paper 9 being fed from the paper feeding roller mechanism 10 contacts to the surface of the photosensitive drum 4 to transfer the toner image onto the surface. A transferring unit 11 applies the charge, which has the opposite polarity to the toner image, onto a back surface of the paper 9, which is brought into contact with the surface of the photosensitive drum 4, to generate the electrostatic force that is used to transfer the toner image, which is formed on the surface of the photosensitive drum 4, onto the paper 9.

A carrying belt 12 constituting another part of the paper carrying means feeds the paper 9, on which the toner image is transferred, to a contact type thermal fixing unit 13 as the fixing means. A pair of fixing rollers 14 consisting of a heat roller 14a and a back-up roller 14b, which are brought into contact with each other by the pressure, heat the paper 9 and apply the pressure to the paper 9 to fix the toner image on the surface of the paper 9.

The paper being sent out from the fixing unit 13 is discharged to a discharging portion 16 or a discharging portion 17 in response to the position of a paper carrying path switching member 15. Otherwise, the paper being sent out from the fixing unit 13 is carried to the discharging portion 17 side in the middle, then is carried to the both-side printing paper feeding path 20 side at a predetermined timing, and then the printing paper whose printing on the front surface has been completed is supplied again to the printer portion 3 to apply the printing on the back surface of the paper.

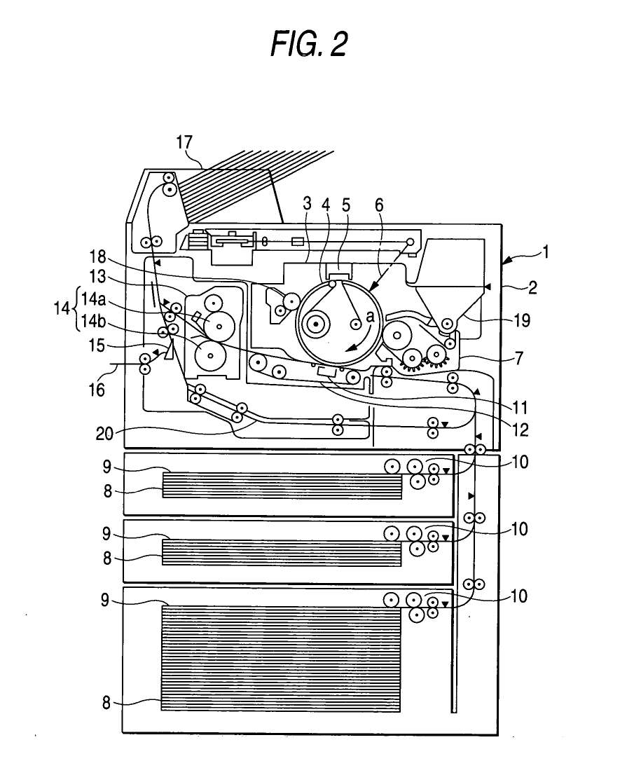

In this case, in FIG. 1, a reference 18 is a cleaning unit that removes the toner and the foreign matters such as the paper powder, which still remain on the surface of the photosensitive drum 4 after the paper 9 passes through the transferring unit 11, from the surface of the photosensitive drum 4. A reference 19 is a toner supplying unit that supplies the toner to the developing unit 7 as the case may be. In this case, the laser beam printer into which the developing unit having one developing roller is installed is shown in FIG. 2, but the developing unit having a plurality of, e.g., more than two developing rollers is installed may be employed. Also, the laser beam printer into which the center feed type developing unit having the developing roller, which is rotated in the same direction as the photosensitive drum, and the developing roller, which is rotated in the opposite direction to the photosensitive drum, may be employed.

As described above, according to the present invention, there can be provided an electrostatic charge image developing toner, which is excellent in the heat resistance, the durability, and the environmental stability and capable of reducing an energy required for the fixing, and an image forming apparatus using the same.

What is claimed is:

1. An electrostatic charge image developing toner, comprising:
a fixing resin; and
one type wax or K type (K is an integer in excess of 1) waxes;
wherein following formulae (1) and (2) are satisfied
$$T = {\sum }_{N = 1}^{k} Tn \cdot Wn / 100 \qquad ( 1 )$$
T≧56 (2)
where Tn (° C.) is an onset temperature of an absorbed heat quantity curve of a wax constitutive component N in a differential scanning calorimeter (DSC), and Wn (wt %) is a compound rate occupied in an overall wax.

2. The electrostatic charge image developing toner according to claim 1,
wherein a melting point of the wax, which is defined as a maximum peak of the absorbed heat quantity curve at a time of temperature rise, is set in a range of 50° C. to 120° C. in a DSC curve measured by the differential scanning calorimeter.

3. The electrostatic charge image developing toner according to claim 1, wherein the wax contains a wax a crystallinity of which is 80% or more but is 93% or less.

4. The electrostatic charge image developing toner according to claim 1, wherein the toner contains at least a vinyl copolymer, which is polymerized in existence of the wax, as the fixing resin.

5. The image forming apparatus comprising:
an electrostatic charge holding member for holding an electrostatic latent image;
a developing unit for developing the electrostatic latent image by using an electrostatic charge image developing toner;
wherein the electrostatic charge image developing toner contains at least a fixing resin and one type wax or K types (K is an integer in excess of 1) waxes, which satisfies following formulae (1) and (2)
$$T = {\sum }_{N = 1}^{k} Tn \cdot Wn / 100 \qquad ( 1 )$$
T≧56 (2)
where Tn (° C.) is an onset temperature of an absorbed heat quantity curve of a wax constitutive component N in a differential scanning calorimeter (DSC), and Wn (wt %) is a compound rate occupied in an overall wax.
